(19) United States
(12) Patent Application Publication
(10) Pub. No.: US 2004/0120728 A1
(43) Pub. Date: Jun. 24, 2004

(54) Web-cleaning apparatus for electrostatic printer/copier

(75) Inventors: Francisco L. Ziegelmuller, Penfield, NY (US); Carol K. Dunn, Rochester, NY (US); Maria B. Carrone, Scottsville, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/625,423

(22) Filed: Jul. 23, 2003

Related U.S. Application Data
(60) Provisional application No. 60/420,048, filed on Oct. 21, 2002.

(51) Int. Cl. G03G 21/00

(52) U.S. Cl. 399/123; 399/350

(57) ABSTRACT

A cleaner for removing particulate material from the surface of a moving web having a customer-replaceable cleaning cartridge including a pair of spaced, parallel cleaning blades supported by a sump housing having an easily removable lid assembly with a narrow opening through which the blades project at an angle, the lid member has slot features for locking it to the sump housing tabs and preferably, the lid member is sealed against the sump housing by compression of a foam gasket; a backup shoe assembly positioned to contact the web surface opposite the cleaning blades and provide resistance to the cleaning blades; and a bracket assembly for releasably supporting the cleaning cartridge in an operative position in which the cleaning blades contact the web surface to be cleaned and cooperate with the shoe assembly to wipe particulate material from the web.

### BACKGROUND OF THE INVENTION

1. Field of the Invention

This invention relates generally to improvements in cleaning apparatus of the type used, for example, in electrostatic document printers or copiers to remove residual toner, carrier, dust, lint, paper fibers and the like from a moving surface, typically in the form of an endless web or drum.

2. Discussion of the Prior Art

Heretofore, blade cleaners have been used in electrophotographic copiers and printers to remove particulate material, e.g., toner, carrier, dust, lint, paper fibers, etc., from various moving surfaces within the instrument. Such surfaces typically include the relatively delicate outer surfaces of image-recording and image-transfer elements, as well as the somewhat less delicate surfaces of endless webs used to transport a sheet material from one image processing station to another.

Blade cleaners are often classified by the way they operate to clean the moving surface they contact. Some operate in a “scraping” mode; others operate in a “wiping” mode. When operating in a scraping mode, the blade element is set at an obtuse angle (typically between 100° and 120°) relative to the oncoming surface it is intended to clean; thus, the blade edge opposes the movement of the surface and deflects particulate material from the surface as it initially engages the blade edge. When operating in a wiping mode, the blade element is set at an acute angle (typically between 60° and 85°) relative to the oncoming surface it is to clean; thus, the blade edge extends slightly in the direction of travel of the moving surface, and particles are wiped from the surface as the web moves away from the blade edge. Obviously, the scraping mode is harsher on the moving surface and usually requires a lubricant to prevent the blade from becoming unstable and tucking under. In applications where considerable amounts of toner (which serves as a blade lubricant) remain on a surface for cleaning, scraping blades are often preferred since they are more flexible to machine configuration. In applications that require long runs without toner or any other self-lubricating material, wiper blades are preferred due to their inherent stability. Both types of blade cleaners (i.e., scrapers and wipers) are disclosed in U.S. Pat. No. 5,426,485 in which cleaning blades serve to remove particulate material from an endless elastic belt used to convey copy sheets in an electrostatic copier. In this patent, the pressure applied by the blade is adjustable as a function of belt temperature.

U.S. Pat. No. 4,866,483 discloses a blade-type cleaning station for a tabletop electrostatic printer. A pair of spaced, parallel cleaning blades, set to operate in a wiping mode, serves to remove residual toner from an endless photoconductive image-recording belt following transfer of a toner image to a copy sheet. The cleaning station further includes a rotatably driven auger for transporting most of the scavenged residual toner collected in a sump to a remote receptacle for removal. The cleaning station is stationary within the printer's base frame, and the entire print engine, including the image-recording belt, is mounted on a pivoting frame for movement between closed and open positions, towards and away from the cleaning station. In its closed position, the print engine's image-recording belt pressingly engages the respective edges of the cleaning blades and is thereby positioned to be cleaned by the blades as the belt advances along its endless path. In its open position, the belt is sufficiently spaced from the blades so that the cleaning station may be readily serviced, e.g., to vacuum scavenged toner from that portion of the sump directly beneath the cleaning blades, or to replace the cleaning blades themselves. Here, the blades are loosely supported at opposite ends in a pair of guide channels formed in the end walls of the sump housing. Each blade has a pair of downwardly depending pegs at opposite ends. These pegs fit into the central portion of a coil spring located in each guide channel, such coil springs acting to urge the blades into contact with the moving belt when the print engine frame has been returned to its closed position. In use, the cleaning blades operate on an unsupported region of the image-recording belt.

While the cleaning station disclosed in U.S. Pat. No. 4,866,483 affords certain advantages not found in prior devices, it may still be viewed as problematic in certain respects. For example, the sump housing that receives toner wiped from the belt surface by the blade cleaners is relatively small, thereby requiring the relatively costly auger system to continuously transport particles to a remote location for storage prior to removal. Further, while ready access may be gained to the cleaning station by simply pivoting the print engine frame to its open position, there is no fool-proof way of removing the scavenged particulate material from the sump blade without some potential for blowing the particles throughout the machine frame. Once the print engine has been pivoted to its open position to gain access to the scavenged particle sump for vacuuming, the entire sump is exposed to ambient air, and any air currents in the vicinity of the open sump can have the effect of blowing toner, etc. throughout the instrument. Ideally, the scavenged particle sump should be easily removed from the vicinity of the machine frame while scavenged particles are confined therein. Once removed, the sump may be discarded and replaced with a new sump, or it may be cleaned at a location safely spaced from the machine and then replaced. Also, since there is no lid or cover on the top of the sump, scavenged particles can escape the sump and contaminate the machine elements while the machine is in operation. Further, since there is no hard backup for the web to resist the pressure applied on the web, and applied by the cleaning blades, the web is likely to stretch over time, thereby changing the dynamics at the blade edge/web interface.

U.S. Pat. No. 6,453,134 discloses an improved blade cleaner having a lid to isolate the removed scavenged particles so that they can not escape the sump and contaminate the machine elements while the machine is in operation, however, U.S. Pat. No. 6,453,134 does not disclose any techniques for simple and easy removal and replacements of the sump assembly.

Therefore, there remains a need within the art for apparatus and techniques for a simplified disassembly and reassembly of the cleaner for servicing, remanufacturing or recycling purposes.

### SUMMARY OF THE INVENTION

The present invention addresses the shortcomings within the prior art by providing apparatus and techniques for a simplified disassembly and reassembly of the cleaner for servicing, remanufacturing or recycling purposes. Specifically, the invention addresses these needs by employing modifications to the sum assembly and specialized techniques using fasteners and foam gaskets to seal the interface of the cover with the sump.

An object of the invention is to provide a relatively low-cost, operator-replaceable cartridge comprising one or more wiper blades enclosed within a particle sump assembly that is easily removed from a printer/copier.

It is an additional object of the invention, to provide a sump assembly in the form of a cartridge that can be serviced away from the machine or, alternatively, discarded and replaced with a new cartridge that can be easily serviced for worn out parts, remanufactured or recycled.

Still, a further object of this invention is to provide an improved method for cleaning particulate material from a moving surface.

The ensuing detailed description of preferred embodiments will make apparent, these and other objects of the invention, in accordance with a first aspect of the invention, by the provision of a web-cleaning apparatus comprising an operator-replaceable cleaning cartridge adapted to be releasably supported by a bracket in a position to engage a moving surface of a web to be cleaned. Such cleaning cartridge comprises a pair of cleaning blades; a sump housing for releasably supporting the blades in a spaced parallel relationship, for receiving and storing particulate material removed from the moving surface by the blades, and with supporting features for locating or locking a baffle, and for latching onto a lid; a baffle to provide a barrier to waste toner outflow within the sump and having holes to locate and lock it to the sump housing, a foam gasket that seals along the perimeter of the interface between the sump and lid, and a lid assembly, operatively connected to said sump housing by cutout slots that mate with tab features on the sump housing to form a substantially enclosed chamber therewith by means of a foam gasket. The sump housing has a pair of opposing end walls, each defining a pair of spaced notches for receiving and supporting an end of one of the blades. The notches are positioned to locate the respective edges of the blades in a spaced, parallel relationship, with each of the flexible blades extending at a predetermined acute angle relative to a planar upper surface of the lid assembly. The lid assembly comprises a lid member defining an elongated opening through which the flexible blade members of the wiper blades project when the wiper blades are supported in the notches of the sump housing. The opening in the lid has a rectilinear lip supporting a flexible seal blade having a rectilinear edge spaced from said wiper blades and extending parallel thereto. The seal blade is substantially more flexible than the flexible blades of the wiper blades and, in addition to sealing the upstream end of the sump housing to prevent the escape of scavenged particles, also operates to deflect into said enclosed chamber particulate material wiped from a moving surface by at least one of the wiper blades. Preferably, the lid member defines an open auxiliary reservoir for receiving any particulate material wiped from the moving surface by the seal blade. Also within the preferred embodiment of the invention contained herein, is the upper surface of the lid member which supports at spaced, parallel locations, two strips of a compressible material which cooperates with the moving surface to prevent particulate material in the sump from escaping from the sides of the sump housing. The cartridge is easily accessible to the operator by using a bracket latched in a releasable manner to a hard backup shoe assembly that can be quickly unlatched and dropped for easy installation, service and removal of the cleaning cartridge. The cartridge-supporting bracket can also be quickly removed from the backup shoe assembly for installation or removal of a transport or transfer web.

In accordance with another aspect of the invention, the web-cleaning apparatus of the invention comprises, in addition to the above-noted cleaning cartridge, a hard back-up member or “shoe” that is positioned on the opposite side of the moving web from the wiper blades of the blade cleaner cartridge. Preferably, the back-up member is part of a two-piece bracket assembly used to releasably support and position the cleaning cartridge relative to the web surface and a backup shoe or pressure plate in order to achieve uniform pressure across the web.

Due to the construction of the operator-replaceable cleaning cartridge, a machine operator can perform periodic maintenance on the cleaner station with minimum downtime. Moreover, the application of the blade cleaners against a stationary hard backup minimizes any adverse effect the cleaner might have on the web-tracking system and on color registration (e.g., in a full color document printer) since the stationary backup does not steer the web and the blades are designed with enough compliance to reduce load variations due to differences in engagement between the front and rear of the cleaner as may be found in other applications where the cleaner blades abut against a roller and the blades are considerably stiffer. Also advantageous is that the auxiliary waste reservoir in the lid assembly serves to contain any particles that are deflected in a direction upstream of the cleaning blades. While the first blade that contacts the web does the bulk of the cleaning work including the function of trapping paper dust, fibers, lint and oil from the transport web, the second blade then continues the cleaning process, thereby extending the good cleaning function of the cleaner over longer periods of time. The dual wiper blades ensure consistency and extended life cleaning performance while avoiding the problems of instability or tuck under encountered with scraper blades. The efficiency of the first blade in trapping fibers, lint and other debris eliminates the need for a fur brush.

The invention and its advantages is better described in the ensuing detailed description of preferred embodiments, with reference being made to the accompanying drawings in which like reference characters denote like parts.

### BRIEF DESCRIPTION OF THE DRAWINGS

The invention and its objects and advantages will become apparent upon reading the following detailed description and upon reference to the drawings, in which:

FIG. 1 is a schematic illustration of an electrostatic document printer in which the invention is useful and is shown as being embodied;

FIG. 2 is a perspective view of a preferred embodiment of the web-cleaning apparatus of the invention, such apparatus shown to be operating on the surface of a sheet-transport web comprising the FIG. 1 printer;

FIG. 3 is a cross-sectional illustration of the FIG. 2 apparatus;

FIG. 4 is a perspective view of three major components of the FIG. 2 apparatus;

FIG. 5 is a perspective view of the customer-replaceable cleaning cartridge comprising the FIG. 2 apparatus;

FIG. 6 is an exploded view of the cleaning cartridge shown in FIG. 5;

FIGS. 7A, 7B and 7C are perspective, front and side elevations of a preferred cleaning blade;

FIG. 8 is a perspective view of the rear end of the cleaner opened to illustrate the mating of an internal baffle to a locating or locking feature on a sump housing;

FIG. 9 is a perspective view of the lid assembly mounting procedure to the rest of the cleaner with the tabs and slot features; and

FIG. 10 is a cross-sectional illustration of the lid mated to the sump with the geometric requirements for the locking features.

### DETAILED DESCRIPTION OF PREFERRED EMBODIMENTS

The preferred embodiment, as described herein, is not intended to disclose all possible variations of the invention, and it should be understood that the described embodiments are only examples of the invention. The scope of the invention is determined by the appended claims. The cleaning apparatus of the invention is adapted for use in an electrostatic printing machine to clean marking particles (toner) and other particulate material. The invention is particularly well adapted for systems employing an endless web used to transport image-receiver sheets. It will be evident from the ensuing description that the invention is equally well suited for use in a wide variety of devices to clean particulate material from different types of moving surfaces.

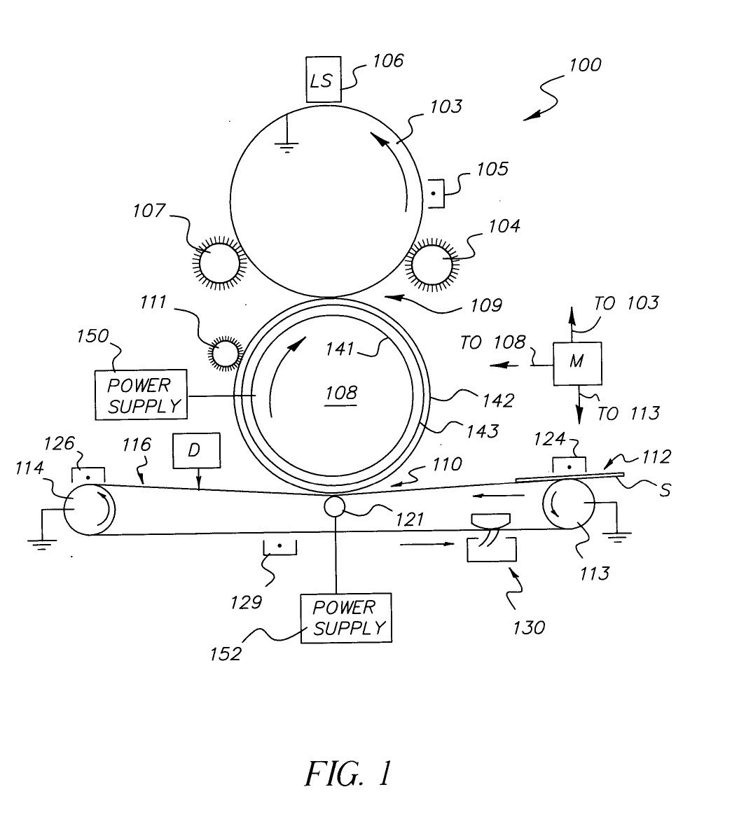

Referring to FIG. 1, a conventional electrophotographic document printer 100 is shown having a primary image-forming member 103, for example a rotatably driven conductive drum having an outer surface of a photoconductive material. One or more transferable toner images are formed on the photoconductive surface of drum 103 by first uniformly charging the surface with electrostatic charge provided by a corona charger 105 or the like. The uniformly charged surface is then imagewise exposed to actinic radiation provided, for example, by a laser scanner 106, thereby selectively discharging the charged surface and leaving behind a latent charge image. Finally, the latent charge image is rendered visible (developed) by applying electroscopic toner particles using a magnetic brush applicator 107, or the like. In some printers of this type, a series of toned process control patches (images) are also formed on the surface of the image-recording element, such patches being located in the interframe region between successive image frames.

The above-noted toner images and toned process control patches are then transferred to an intermediate image-transfer member 108 at a transfer nip 109. Any residual toner on the image-recording member 103 is removed by a cleaning brush 104 prior to recycling the image-recording member through the image-forming process. The image-transfer member may comprise, for example, an electrically conductive drum 141 having a compliant blanket 143 with a relatively hard overcoat 142. The conductive drum is electrically biased by a power supply 150. The toner images transferred onto an intermediate image-transfer member are then re-transferred to an image-receiver sheet S at a second image-transfer nip 110 formed by a relatively small transfer roller 121 and an endless sheet-transport web 116 made of a dielectric material such as a polymer compound. The toner images are electrostatically attracted to the image-receiver sheets by a suitable electrical bias applied to transfer roller 121 by a power supply 152. A cleaning brush 111 removes residual toner on image-transfer member 108.

The image-receiver sheets are presented to the endless transport web 116 at a sheet-feed station 112. Web 116 is trained around a pair of rollers 113 and 114, and a motor M serves to drive roller 113 in the direction indicated by the arrow. Motor M also serves to rotatably drive the image-recording and image-transfer drums. The image-receiver sheets (e.g., paper or plastic) attach to transport web 116 at a corona charging station 124, which operates to charge the top surface of the sheet so that it becomes electrostatically attracted to the web. The grounded rollers 113 and 114 serve to charge to the backside of the web. A corona charger 126 serves to detack the image-receiver sheets as they wrap around transport roll 114, thereby freeing the sheets for further transport to a toner fusing station, not shown. Note, being outside the image frame areas on the image-recording drum, any toned process-control patches transferred to the image-transfer member 108 will re-transfer directly to the transport web in the region between successive image-receiver sheets. These toned patches must be removed from the web before receiving a new image-transfer sheet. Otherwise, the toner from these patches will transfer to the rear side of the image-receiver sheets. An electrophotographic document of the type described shown in FIG. 1 is more thoroughly described in U.S. Pat. No. 6,075,965, issued on Jun. 13, 2000 in the names of Tombs et al., the contents of which are incorporated herein by reference.

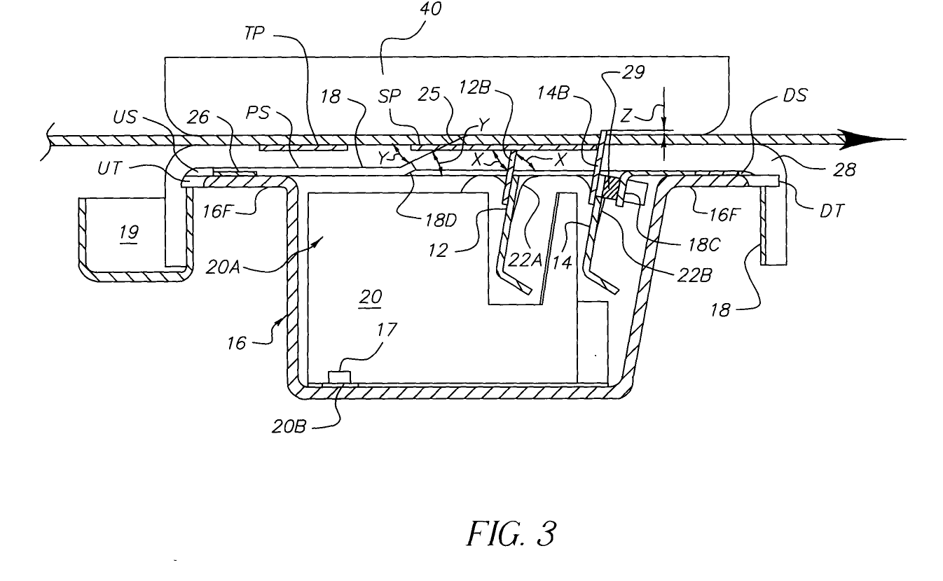

The new and improved web-cleaning apparatus 130 provided by the invention removes not only the random toner particles, dust, paper debris, and the like that may accumulate on the outer surface of the transport web 116 during repeated use of the printing machine described above, but also removes any relatively heavy deposits of toner that may be transferred to the web. Toner can accumulate, as a result of forming the aforementioned process-control patches on the image-recording drum, paper jams, misregistration of a toner image to the image-receiver sheet, or the like. As indicated above, such toned patches (designated as TP in FIG. 3) are formed at predetermined locations on the recording element(s) in the interframe areas and are used, for example, to control registration of multiple color-separated images on the surface of a single image-receiver sheet and/or to monitor the effectiveness of the image-forming process across the width of the recording element. These patches get transferred to the web in the spaces between successive image-receiver sheets and are “read” on the web by a densitometer D located downstream of the image-transfer nip 110. As will be appreciated, all particles on the sheet-bearing surface of transport web 116 should be removed or cleaned from the web before the web receives a new image-receiver sheet. The web-cleaning apparatus of the invention, generally designated as 130 is particularly well adapted to perform this duty and, as shown, is positioned downstream of a transport web conditioning charger 129 that acts to discharge the web surface to facilitate the cleaning function.

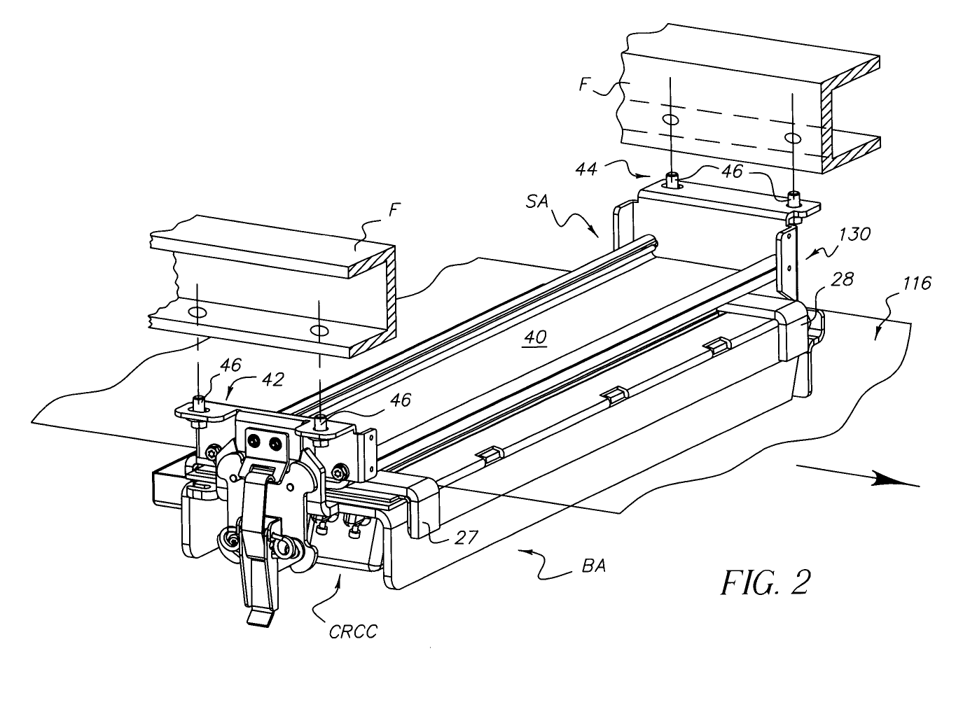

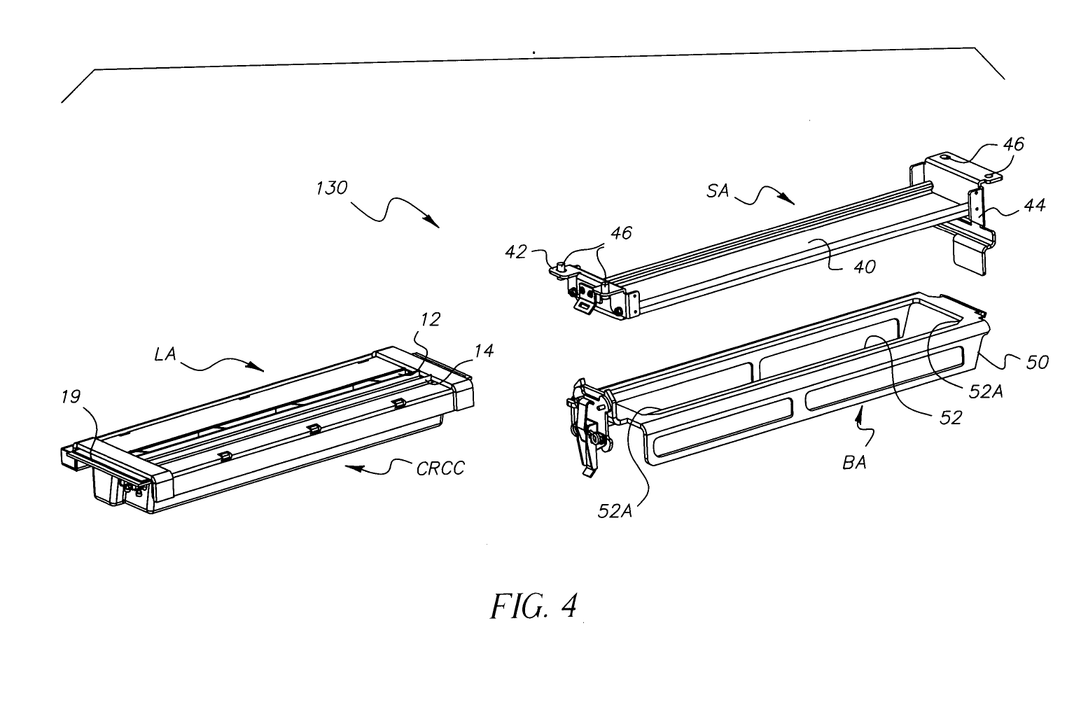

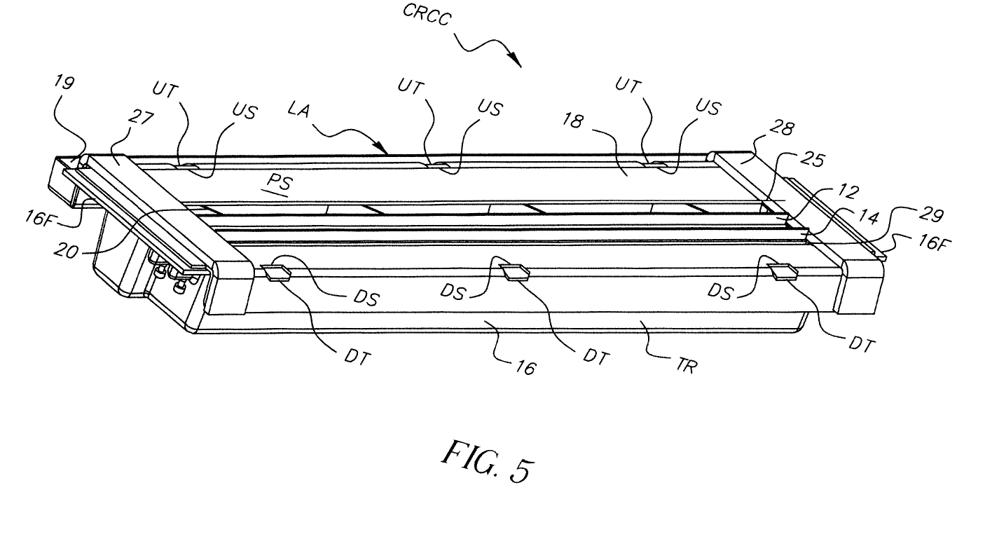

Referring in general to FIGS. 2-6 with particular attention to FIG. 4, the preferred web-cleaning apparatus 130 is shown including three major components. A customer-replaceable cleaning cartridge CRCC that provides a web-cleaning function, a bracket assembly BA for releasably supporting the CRCC in an operative position within the printing machine adjacent to the web surface to be cleaned, and a back-up shoe assembly SA for providing a hard resistance to the pressure applied on the web by the CRCC. Auxiliary reservoir 19 provides an exterior container for particulate that is for one reason or another trapped outside of the CRCC. As described in commonly assigned U.S. application Ser. No. 09/738,751, the shoe assembly SA serves to support the bracket assembly BA in a releasable manner. Movement is facilitated between an operative position, in which the bracket assembly BA supports the CRCC in a position that engages transport web 116, and a service position in which the bracket assembly BA is supported in a position spaced from the web so that the CRCC can be readily removed from the machine and/or serviced. The bracket assembly BA is formed from frame 50 with frame opening 52 and edge features 52A. The shoe assembly SA is formed from hard shoe 40, which provides rigidity for the bracket assembly BA. The shoe assembly SA has front and rear bracket portions 42, 44 to support the bracket assembly BA. The shoe assembly mounting features 46 are formed as slots to facilitate the fastening of the web-cleaning apparatus 130 onto the machine in juxtaposition to facilitate web cleaning.

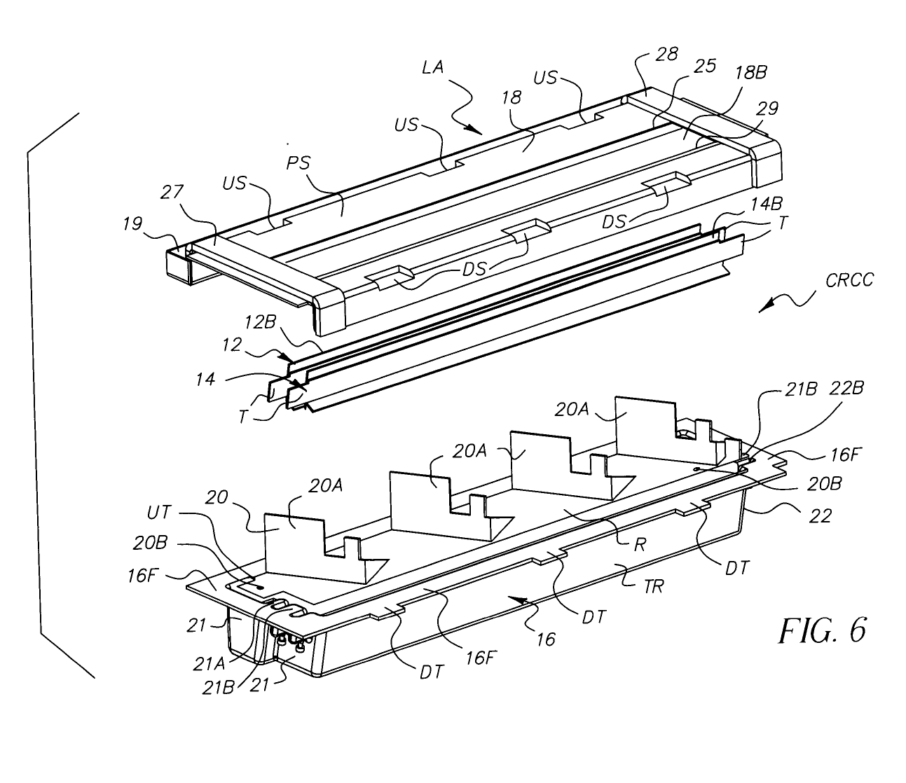

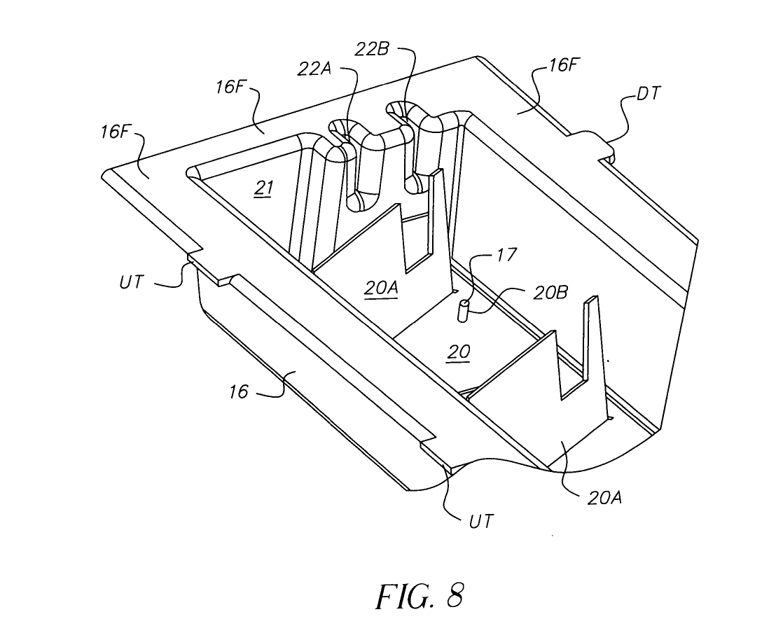

Referring to FIGS. 3, 5, 6 and 8, the CRCC includes a pair of cleaning blades 12, 14 adapted to contact the outer surface of transport web 116 and to wipe particulate material from the transport web 116; a sump housing 16 for releasably supporting the cleaning blades in a spaced parallel relationship and for receiving and storing particulate material removed or scavenged from the outer surface of transport web 116 by the cleaning blades; and a multi-purpose lid assembly LA attached to the top of the sump housing that serves not only to prevent scavenged particles from escaping the edges of the sump housing, but also to both clean the edges of the web and collect particles deflected from the web by a seal blade (described below) at a location upstream of the cleaning blades. Optionally, the CRCC further comprises an internal baffle 20 (shown in FIGS. 6, and 8) that is positioned within the sump housing to prevent any sudden displacement and subsequent spillage of scavenged particles as the aforementioned bracket assembly BA is moved to its service position in which the CRCC can be removed from the machine. Preferably, the sump housing, and the baffle 20 are made from an injection-molded plastic having a carbon doping for static dissipative purposes to avoid excessive charge build up. The volume resistivity of the plastic used for the sump housing and the baffle 20 is preferably between 108 to 1011 ohm-cm. Other possible materials made be of metallic nature such as aluminum or steel.

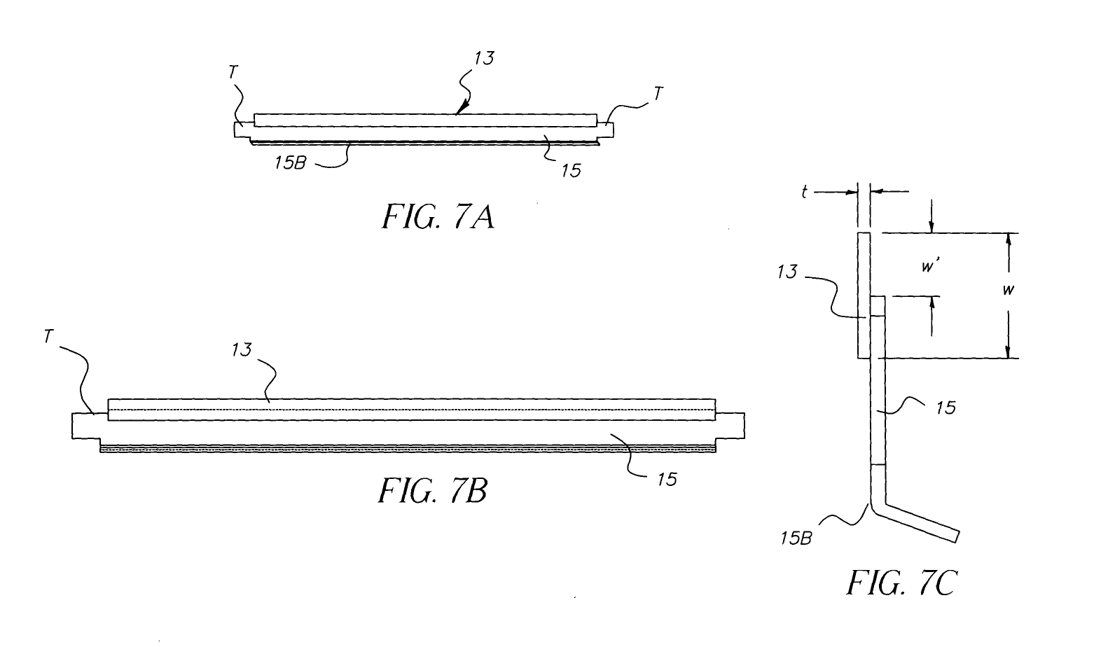

Referring to FIGS. 7A-7C, each of the cleaning blades 12, 14 comprises a flexible blade element 13 and a rigid stiffening plate 15. The flexible blade element 13 preferably comprises a rectangular slab of polyester polyurethane with the following properties: a hardness of between 60 and 85 Shore A, an initial modulus of between 500 and 1500 psi, a Bayshore resiliency above 30%, and a compression set lower than 25%. The polyurethane slab is fabricated with a thickness t of about 0.050″ and a width w of 0.500″. The length of the flexible blade elements may be equal to the width of transport web 116; preferably, the blades extend about 12 mm to about 25 mm beyond each of the edges of the widest image-receiver sheet size, but within the belt width. The polyurethane slab is glued to the stiffener plate, the latter preferably being made of steel, so as to produce a free extension w′ of 0.250″ (see FIG. 7C). In general, the ratio of the polyurethane thickness to the free extension should be between 0.125″ to 0.250″. As shown, the steel stiffener plate 15 is provided with a bend 15B along one edge thereof, thereby giving the plate a somewhat L-shaped cross-section. The purpose of the bend is to reduce any bending tendency of the plate along its length. The bend angle is preferably between 90° and 150°, and it should be such as not to provide a barrier to particle flow into the sump. A pair of opposing extension tabs T is provided on each stiffener plate for mounting the blades on the sump housing 16. Tabs T are designed so that they rest on the respective bottom surfaces of a pair of supporting notches formed in the sump housing side walls, as described below. When so seated, the cleaning blades are in a locked position relative to the direction of motion of the web. Preferably, prior to use, the flexible blade edges are initially dusted with toner, Teflon®, Kynar®, PMMA®, zinc stearate or other suitable dry lubricant to reduce friction with the web at installation.

As best shown in the exploded view of the CRCC shown in FIG. 6, sump housing 16 comprises a generally rectangular tray TR, preferably made of plastic and injection-molded, that defines a reservoir for receiving particulate material removed from the transport web. The tray has four mutually perpendicular flanges 16F by which it is supported by the support bracket assembly BA. These perpendicular flanges 16F support the mounting of a foam gasket 26 which will be compressed between the lid assembly LA and the sump housing 16 where these parts are attached. The foam gasket 26 should be placed flat over flanges 16F after the cleaning blades 12, 14 and the baffle 20 have been installed into the sump housing 16. The material for foam gasket 26 should have a low density, a low compression set and high resiliency. R200/U polyester with a density of 2 lb/cubic feet is an example of a suitable material for foam gasket 26. The sump housing flanges 16F define the shape of foam gasket 26 to seal along their perimeter. The foam gasket 26 should be narrower than flanges 16F to minimize chances of gasket overhanging. The thickness of foam gasket 26 should be selected to minimize drag torque on the sheet-transport web by the lid assembly elements. The flanges 16F also feature sets of upstream tabs UT and downstream tabs DT that allow for locking of a lid assembly LA. The tray TR has a pair of opposing sidewalls 21, 22. Each sidewall defines a pair of notches, i.e., notches 21A, 21B in sidewall 21, and notches 22A, 22B in sidewall 22. As indicated above, these notches are shaped to support the mounting tabs T extending axially from the respective ends of the cleaning blades 12 and 14. The notches are so located and oriented in the sidewalls as to support the two cleaning blades in a spaced, parallel relationship, with the blade elements 12B and 14B being arranged at an acute angle X relative to the upper planar surface PS of a lid member 18 comprising the lid assembly LA. In use, the CRCC is supported (by the bracket assembly BA) in an operative position with respect to the web surface such that the blades are arranged at an acute angle X (shown in FIG. 3) relative to the oncoming web surface (i.e., the upstream portion of the web). Thus, the blade elements will be supported in a “wiping” mode, as explained above. The CRCC is designed so that no fasteners are needed to mount the cleaning blades on the sump housing or the lid assembly to the sump housing with the foam gasket trapped in place. The blades are installed by simply dropping the extension tabs T of the blades into the notches of the sump housing; thus, the blades are removed by simply lifting them out of their supporting notches. Blade-supporting notches 21A, 21B, 22A, 22B are arranged so as to produce a predetermined and desired wiping angle and interference with the surface to be cleaned. Preferably, the wiping angle is to be between 60° and 85°, and most preferably about 80°. The amount of blade interference Z with the web surface (shown in FIG. 3) depends on the stiffness of the blade and the desired load to clean. In general, this interference can be between 0.010″ to 0.100″, and is preferably between 0.010″ and 0.060″, and a normal load is within the range of from 10 to 60 g/cm. It is contemplated that it may be desirable to set the first blade at a lower load so as to function primarily as the cleaner of the bulk of the toned patches and a trapper of lint, paper dust and oil, while the second blade is set at a higher load to complete the cleaning operation. This result can be achieved by making adjustments to the cleaning blades (e.g., by varying the thickness t, width w, or material of the flexible wiper elements 12B, 14B) and/or by varying the depth of the blade-supporting notches in the sump housing. In this embodiment, it is preferred that both blades be set at the same load. A preferred spacing between the two cleaning blades is between 0.250″ and 0.750″ to reduce any chance of toner spilling while allowing enough room for particles to flow down into the sump.

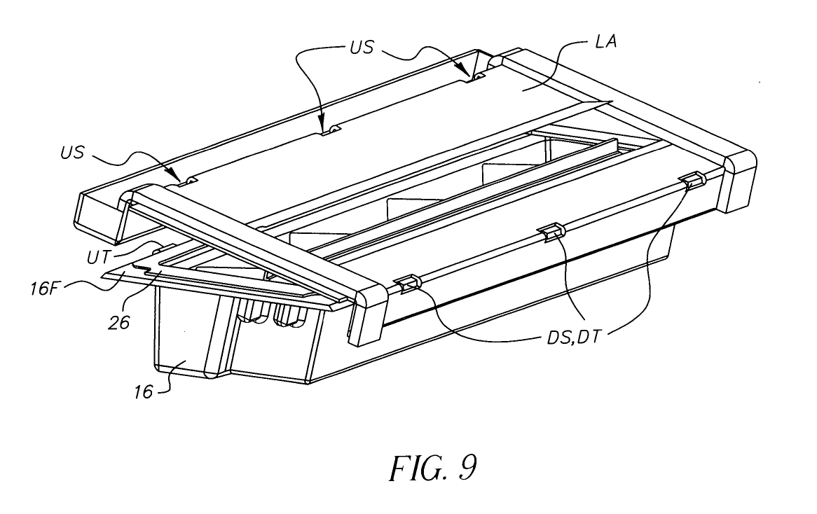

The multi-purpose lid assembly LA includes a lid member 18 that cooperates with the sump housing to provide an enclosed chamber for particulate material scavenged from the web. Lid member 18 is preferably fabricated from a static dissipative plastic material; it may, however, be made of a lightweight metal, such as aluminum or even steel. Preferably, the lid member 18 is designed to snap onto the top of the sump housing flanges by insertion of the lid downstream of slots DS to the longer downstream tabs DT in the sump. By shifting the lid over to the upstream side and then rotating the lid down until the upstream slots US snap into the narrower upstream tabs UT at the sump housing 16 and over the foam gasket 26 which had been placed flat over the sump housing flanges 16F (FIG. 9). While the preferred embodiment employs three tabs on each side of the sump housing is shown, other combination of tabs and mating slots may be used to accomplish the locking function without fasteners. To remove the lid assembly, it must be shifted to the left of the sump housing and the housing should be squeezed at the center of the tray TR to allow the tabs to retract from the slots at the upstream side. Another technique is to press on the upstream tabs against the slots while pulling the tray TR down from the lid assembly.

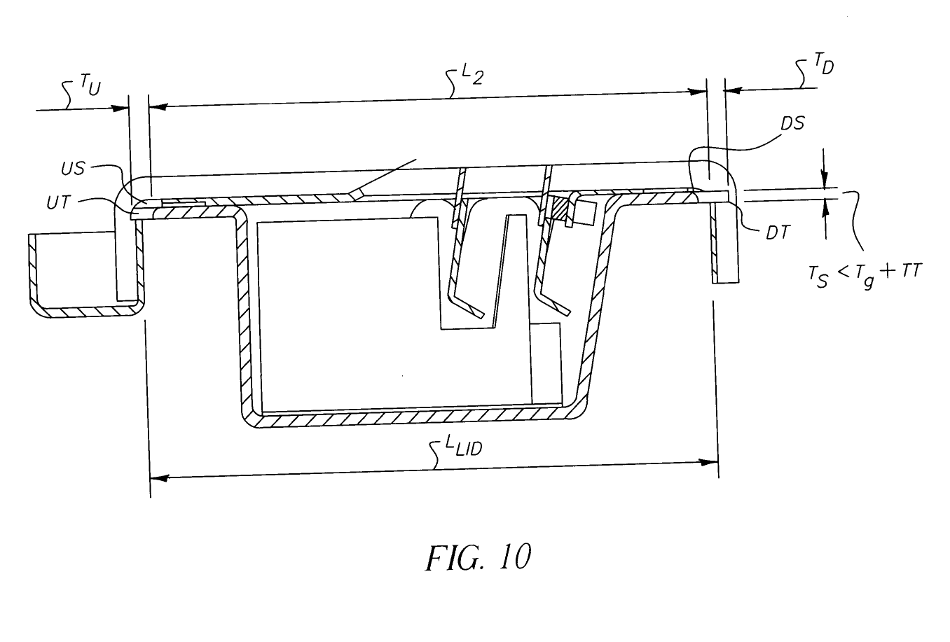

The upstream tabs UT protrude less than the downstream tabs DT from the sump housing 16, however they all have the same width and the same thickness. The upstream tabs UT are fabricated to have ramped edges in order to facilitate the snap on attachment. In order to insure that the lid is a tight snap-on attachment, it is preferable that the L2<Llid<(L2+Tu); wherein Tu is the extension of the upstream tab UT from the sump housing flange 16F, Td is the extension of the downstream tab UT from the sump housing flange in the opposite side, L2 is the length between the opposite sump housing flanges and Llid is the length between the internal and opposite sides on the lid as shown in FIG. 10.

To create an easy fit attachment of the lid on the sump housing, the invention provides for a shift of the lid to the downstream side after mating of the upstream slots US over their corresponding tabs UT. This can be accomplished by setting the following: (L2+Tu)≦Llid<(L2+Tu+Td). It is also preferred that the foam gasket be sufficiently compressed, that sliding of the lid on the sump housing will not occur. Accordingly, the following relationship is preferred: Ts<Tg+TT; where Ts is the internal height of a slot, Tg is the foam gasket 26 thickness and TT is the thickness of the tabs. In general, a 20 to 35% compression of the foam is desirable. The slots should be slightly wider than the tabs. These above dimensions would allow for the locking of the lid assembly LA to the sump housing 16 as shown in FIG. 10.

As shown in FIG. 6, lid member 18 has a substantially planar top surface PS in which a substantially rectangular opening 18B is formed. Blade elements 12B and 14B of the cleaning blades project though this opening when the blades are seated in the sump housing 16. A flange 18C, best shown in FIG. 3, extends downwardly from the downstream edge of opening 18B and serves to provide backup support for a foam seal 29 located behind the second cleaning blade 14. Foam seal 29 operates to seal the downstream end of the cartridge from loss of scavenged particles through opening 18B behind the second cleaning blade. Foam seal 29 does not contact the moving web and it should be separated from the web by at least 0.075″ to prevent possible toner recontamination due to slight build up of toner from the collisions of the blade elements with the splice SP in transport web 116. Foam seal 29 should also be compressed against the stiffening plate 15 of the second cleaning blade by 20-35% and it is attached to flange 18C by use of an adhesive layer on one of its sides and wrapped around the edges of the flange. The preferred foam seal material should have low density, low compression set and high resilience such as R200/U polyester having a density of 2 lb/cubic feet.

A second flange 18D extending upwardly from the upstream edge of opening 18B at an angle Y serves to support a thin, flexible seal blade 25 that projects upwardly from lid member 18, generally towards the first cleaning blade 12. In addition to sealing the upstream end of the cartridge from a loss of scavenged particles during use, seal blade 25 also acts to deflect particles wiped from the web by blade 12 toward and through the lid opening 18B and ultimately into the underlying sump. The gap between the free edge of seal blade 25 and the first cleaning blade 12 is relatively narrow, preferably being between 0.150″ and 0.750″ in width to minimize scavenged particle spillage or leakage. Seal blade 25 is relatively thin (e.g., less than 0.004″) and extends at a relatively shallow angle Y (see FIG. 3) between 15° and 30° relative to the web surface. At such an angle, the seal blade has minimal effect on scavenging particulate material from the web. The seal blade dimensions are selected to minimize waviness in the blade edge. Several materials are preferred, including polyester, nylon, polycarbonate, polyethylene, and the thickness of seal blade 25 is preferably less than 0.0025″. The free extension of blade 25 (i.e., that part that extends beyond the edge of tab 18A) is preferably less than 1″ to minimize waves but more than 0.100″ to maintain a flexibility that prevents particle scavenging. The preferred range of free extension is between 0.300″ and 0.600″. The seal blade comes with an adhesive layer which surface matches the outside surface of flange 18D. Flange 18D must be rigid and flat to minimize stress on the adhesive and waviness of the seal. The engagement of the seal blade with the transport web 116 over the shoe 40 is between 0.020″ and 0.100″ depending on the other parameters selected such as free extension and thickness. Preferably, the forward end of lid member 18 is shaped to define an elongated cavity 19 that extends across the entire width of the lid and operates as an auxiliary external sump adapted to collect and contain any particulate material that may get deflected from the web upstream of the intended web-cleaning location (e.g., by seal blade 25).

Lid assembly LA further comprises a pair of foam seals 27, 28 that are attached to lid member 18 at both sides of the sump housing. These seals serve both to minimize any leakage of scavenged particles out of the sides of the sump during use of the cleaning apparatus, and to wipe particles from the sides of the web. Each seal has an adhesive on the side facing the lid member and a wear-resistant fabric, e.g., Nylon, on the side facing the web. The foam portion of the seal needs to be of high resiliency, low density, and a low compression set to maintain a good seal and to reduce any drag torque on the transport web 116. A preferred foam material is R200/U polyester having a density of 2 lb/cubic foot. The Tricot™ fabric also serves to reduce friction between the web surface and the seal, and it provides some cleaning of the web surface not covered by the blades.

Baffle 20 is made out of static dissipative plastic or metal such as aluminum or steel. Preferably, it is fabricated as a separate part to be installed into the sump or it is fabricated as in integral part of the injection mold. The baffle 20 comprises a plurality of spaced walls 20A that are arranged at a common angle, between about 15° and 45°, relative to the sidewalls of the sump housing. Walls 20A serve to drive scavenged particles toward the upstream side of the sump whenever the CRCC is dropped at the front for removal or servicing. The baffle 20 is also designed to extend from side to side of the reservoir or as much as possible and the walls 20A are higher in front of the first blade since the reservoir is designed to have most storage capacity or volume in front of the first blade 12. Two baffle holes 20B are mated over protrusions 17 at the bottom of the sump housing as shown in FIGS. 3 and 8. After mating the baffle in the protrusions, it may be desirable to heat stake them to lock the baffle in place. This would facilitate remanufacturing, as the baffle would not fall off the sumps as they are being prepared for reuse. For recycling operation, it may be better to not lock the baffle in the sump housing to allow for separation between plastic and metal parts.

A CRCC fabricated with the above features enables the replacement of worn out parts such as the cleaning blades or the lid assembly while reusing the sump housing and baffle. Waste toner could be disposed of into an anti-static plastic bag and sealed with a twist tie. These features would also enable recycling and remanufacturing of the cleaner components if needed.

Referring to FIG. 2, the shoe assembly SA comprises of a hard shoe 40 having a conductive and wear-resistant surface to avoid charge buildup. Shoe 40 has a large radius to provide hard backing to both cleaning blades. Shoe assembly SA further comprises a front bracket portion 42 with features to allow precise positioning of the CRCC with respect to the shoe and a latching function with respect to the bracket assembly BA, and a rear bracket portion 44 having a slot feature that provides precise positioning of the cleaner cartridge with respect to the shoe. The shoe assembly is positioned to the web frame to allow the shoe to generate some wrap with the transport web. The back-up shoe assembly SA is rigidly connected to the web-transport frame F by a series of mounting features 46. These mounting features 46 include a set of open slots at the rear that greatly facilitates the installation or removal of the shoe assembly since the locking bolts need only be loosened to remove the assembly and the bolts are arranged outwards to face the rear bracket so the operator can easily see these fasteners. These features on the rear bracket are improvements in the assembly of the invention not previously disclosed in U.S. Pat. No. 6,453,134; thus, the back-up shoe assembly SA remains fixed in the printing machine.

Referring again to FIG. 4, the bracket assembly BA that supports the CRCC comprises a frame 50 having a rectangular opening 52 adapted to receive and support the CRCC's sump housing 16. The CRCC is installed in the bracket assembly by simply separating the bracket assembly from the back-up shoe assembly and dropping the sump housing 16 into opening 52. An edge feature 52A on frame 50 assures that the CRCC is received in the proper orientation, i.e., so that the cleaning blades operate in a wiping mode.

While the invention has been described in detail with particular reference to a presently preferred embodiment, it will be understood that variations can be effected without departing from the spirit and scope of the invention.

### Parts List

100 document printer

103 image-forming member

104 cleaning brush

105 primary corona charger

106 laser scanner

107 magnetic brush applicator

108 image-transfer member

109 image-transfer nip

110 second image-transfer nip

111 cleaning brush

112 sheet-feed station

113, 114 web-transport rollers

116 sheet-transport web

121 transfer roller

124 corona charger

126 detack charger

129 conditioning chargers

130 web-cleaning apparatus

141 electrically conductive drum

142 hard overcoat

143 compliant blanket

150, 152 power supplies

12, 14 cleaning blades

12B, 14B blade elements

13 flexible blade element

15 stiffening plate

15B bend in stiffening plate

16 sump housing

16F flanges on sump housing

17 protrusions on sump housing for mating with baffle

18 lid member

18B blade opening in lid member

18C, 18D flanges on lid member

19 cavity/auxiliary reservoir

baffle

20A baffle walls

20B baffle locating holes

21,22 sidewalls of sump housing

21A, 21B; 22A, 22B blade-receiving notches

25 front seal blade

26 foam gasket

27, 28 side seals

29 foam seal

40 hard shoe

42, 44 front and rear bracket portions

46 mounting features

50 bracket assembly frame

52 frame opening for CRCC

52A edge features

D densitometer

F web transport frame

M motor

R reservoir

S image-receiver sheets

t blade thickness

T blade extension tabs

w blade width

X angle between PS and blade elements

Y seal blade mounting angle

Z blade interface with web surface

BA bracket assembly

LA lid assembly

SA shoe assembly

PS planar surface on lid member

TR tray

TP toner patches

SP splice on sheet-transport web

CRCC customer-replaceable cleaning cartridge

UT upstream tabs on sump housing for mating with US

DT downstream tabs on sump housing for mating with DS

US upstream slots on lid member

DS downstream slots on lid member

Tu extension of UT from the flange 16F

Td extension of DT from the flange 16F

Llid internal length between the slots on lid 18

L2 length between edges of flanges 16F

Tg thickness of foam gasket

TT thickness of UT, DT, flanges 16F

Ts internal height or opening of slot on lid 18

What is claimed is:

1. A cleaning cartridge adapted for use in a web-cleaning apparatus for removing particulate material from a surface of a moving web, said cartridge comprising:
(a) at least one cleaning blade, said cleaning blade having an elongated rigid member with a rectilinear edge and a flexible blade element extension;
(b) a sump housing for receiving and storing particulate material, said sump housing having opposing side walls shaped to receive and support therebetween said cleaning blade in a predetermined position, said sump housing further comprising a first set of features; and
(c) a lid assembly in a removable secured relation with said sump housing to form an enclosed chamber with said sump housing, said lid assembly comprising a lid member having a substantially planar upper surface with an elongated opening through which the flexible blade members of said cleaning blades project, and said lid assembly further comprising a second set of features that mate with said first set of features.

2. The cleaning cartridge of claim 1, wherein said sump housing further comprises an attachment mechanism that holds said baffle in its desired position.

3. The cleaning cartridge of claim 1, wherein said sump housing further comprises as said first set of features a plurality of tabs located on opposite sides of said sump housing.

4. The cleaning cartridge of claim 3, wherein said lid assembly further comprises as said second set of features a plurality of slots that mate with said plurality of tabs to form an attachment mechanism.

5. The cleaning cartridge of claim 3, wherein said plurality of tabs further comprise a set of upstream tabs located on the upstream side of said sump assembly and a set of downstream tabs located on the downstream side of said sump assembly.

6. The cleaning cartridge of claim 5, wherein said plurality of tabs further comprises at least one of said sets having a ramped edge to facilitate snap on engagement with said lid.

7. The cleaning cartridge as defined by claim 1, further comprising a baffle that fits within said sump housing in a predetermined position.

8. The cleaning cartridge of claim 7, further comprising a gasket between said sump housing and said lid, said gasket being compressed by the mating of said first set of features with said second set of features.

9. The cleaning cartridge of claim 1, further comprising a bracket for supporting said sump.

10. The cleaning cartridge of claim 1, wherein said bracket further comprises at least one assembly mounting feature that is formed as a slot to facilitate ease of replacement of said shoe assembly.
